(19) United States
(12) Patent Application Publication
(10) Pub. No.: US 2005/0166714 A1
(43) Pub. Date: Aug. 4, 2005

(54) Sprocket drive wrench

(76) Inventor: Joshua Brandon Fowler, Raleigh, NC (US)

Correspondence Address: Joshua Brandon Fowler, PO Box 10123, Raleigh, NC, 27605, US

(21) Appl. No.: 10/766,553

(22) Filed: Jan. 29, 2004

(51) Int. Cl. B25B 17/00

(52) U.S. Cl. 81/57.3

(57) ABSTRACT

The SPROCKET DRIVE WRENCH is a mechanical hand tool to be used in the tightening or loosening of nuts, bolts, fasteners, and component securing devices where lever arm sweep is limited by existing non-movable structure.

### BACKGROUND OF INVENTION

### FIELD OF INVENTION

The field of invention relates to mechanical hand tools particularly to wrenches.

Nuts and bolts are a primary means of securing parts in the manufacture of products. Where removal or installation of fasteners is required, hand tools are utilized to a great extent. In certain applications socket wrenches are the applicable tool but lever are sweep is obstructed. The task becomes time consuming and could become costly. Some hand tools with ratchet capabilities allow users to tighten or loosen fasteners but not in confined areas where optimal clockwise or counter-clockwise sweeping motion is not available. Some tools have the capability of driving the fastener from the operator end. However, profile clearance is bulky and the addition of sockets to the adapter makes the profile more of a problem.

There is a need for a Sprocket driven wrench, which has a low profile, high torque capacity, high-speed rotation ability, and has the ability to be modified by the operator to fit any standard size fastener. The SPROCKET DRIVE WRENCH is capable of tightening or loosening fasteners in spaces where lever arm sweep is insufficient, difficult, or impossible. Also, the SPROCKET DRIVE WRENCH can be attached to multiple SPROCKET DRIVE WRENCHES to reach greater lengths and depths with minimal loss of efficiency.

### PRINCIPAL OBJECTS OF THE INVENTION

It is the main objective of the SPROCKET DRIVE WRENCH invention to provide a tool that can loosen or tighten fasteners by means of a drive belt turning two opposite end sprockets.

It is also the objective of the SPROCKET DRIVE WRENCH to be equipped with a locking device to give means of being used as a common wrench.

It is also the objective of the SPROCKET DRIVE WRENCH to be modified on site with accompanying adapters that fit all standard sized fasteners.

It is also the objective of the SPROCKET DRIVE WRENCH to be driven by an impact gun, ratchet wrench, socket wrench, or other tools fitting the drive-end adapter.

It is also the objective of the SPROCKET DRIVE WRENCH to work in a single plane with unlimited rotation about an axis.

It is also the objective of the SPROCKET DRIVE WRENCH to be attached to more than one SPROCKET DRIVE WRENCH to increase length and depth of task.

It is also the objective of the SPROCKET DRIVE WRENCH to be manufactured in a manner that in the event of material or component failure, replacement parts can be purchased and replaced utilizing minimal effort.

### BRIEF SUMMARY of the INVENTION

The SPROCKET DRIVE WRENCH is a versatile tool capable of tightening or loosening fasteners by use of a sprocket chain drive or belt chain drive, located within the tool itself. The wrench would be designed to work on English unit (inche) and SI unit (millimeter) fasteners and capable of being fitted with variable drive shaft sizes. The fastener end of the wrench would be placed over the fastener. Where conventional wrenches would require clockwise rotation for tightening or counter-clockwise rotation for loosening, the SPROCKET DRIVE WRENCH would remain stationary. A drill or socket driver would be attached to the drive end of the wrench and rotated as required, depending on the application. In situations where lever arm sweep is difficult, the SPROCKET DRIVE WRENCH would accomplish tasks faster and easier.

### BRIEF DESCRIPTION DRAWINGS

FIG. 1 is a top view of the main housing.

FIG. 2 is an elevation view of the main housing.

FIG. 3 is a top view of the access covers.

FIG. 4 is a top view of the Drive Belt.

FIG. 5 is a top view of the belt linkage.

FIG. 5a is an elevation view of a belt linkage.

FIG. 6 is a top view of the Drive-End Sprocket.

FIG. 6a is an elevation view of the Drive-End Sprocket.

FIG. 7 is a top view of the Fastener-End Sprocket.

FIG. 7a is an elevation view of the Fastener-End Sprocket.

FIG. 8 is a top view of locking device.

FIG. 8a is an elevation view of the locking device.

FIG. 9 Is a South West Isometric view of exploded assembly.

FIG. 10 is a Top view of a sectional cutaway for internal assembly view.

FIG. 11 is a South West Isometric view of Section Cutaway.

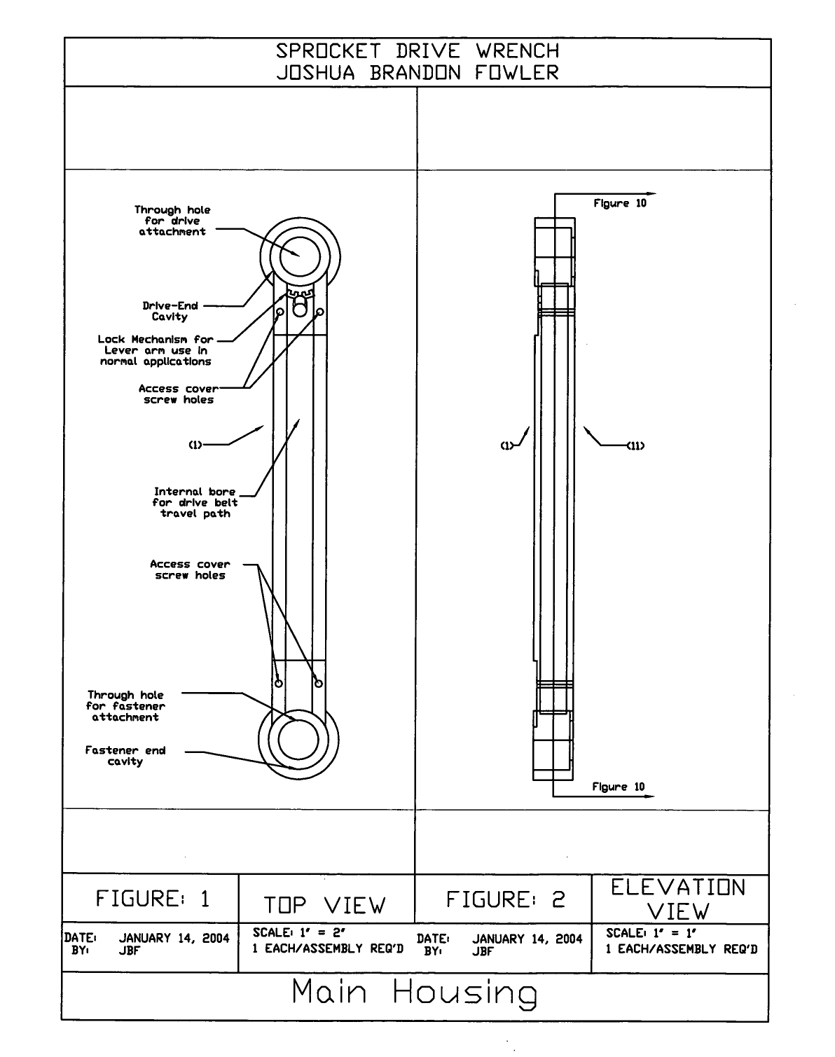

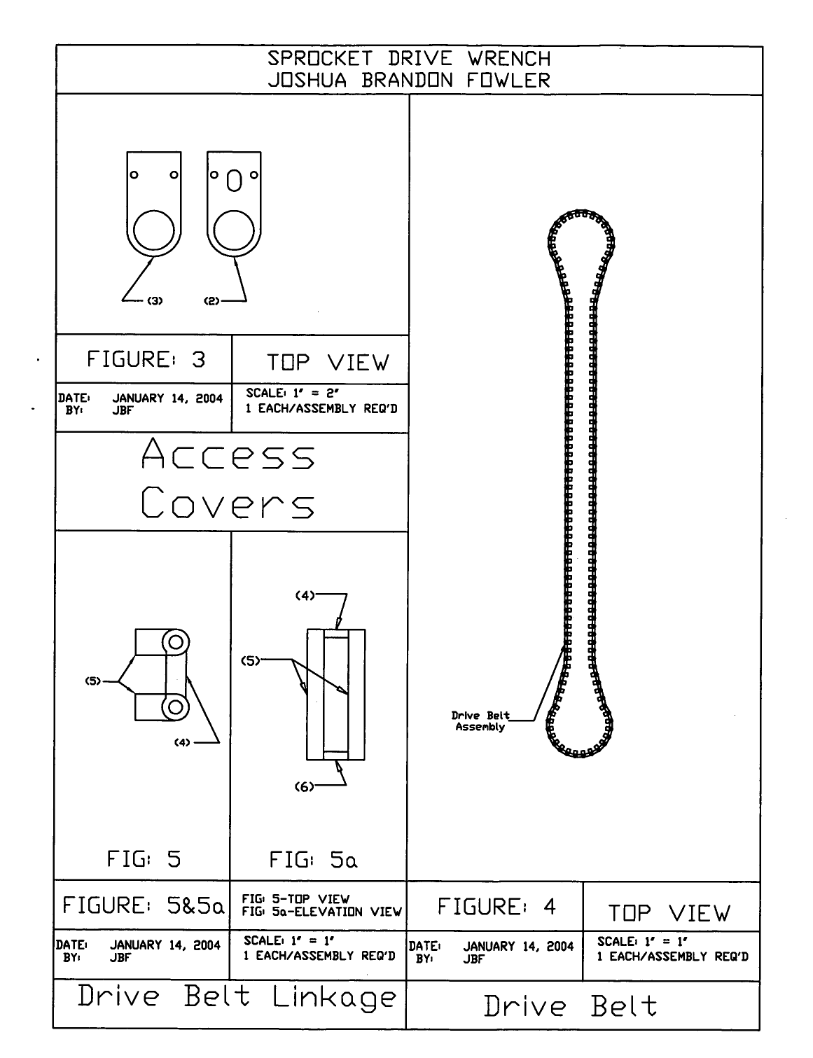

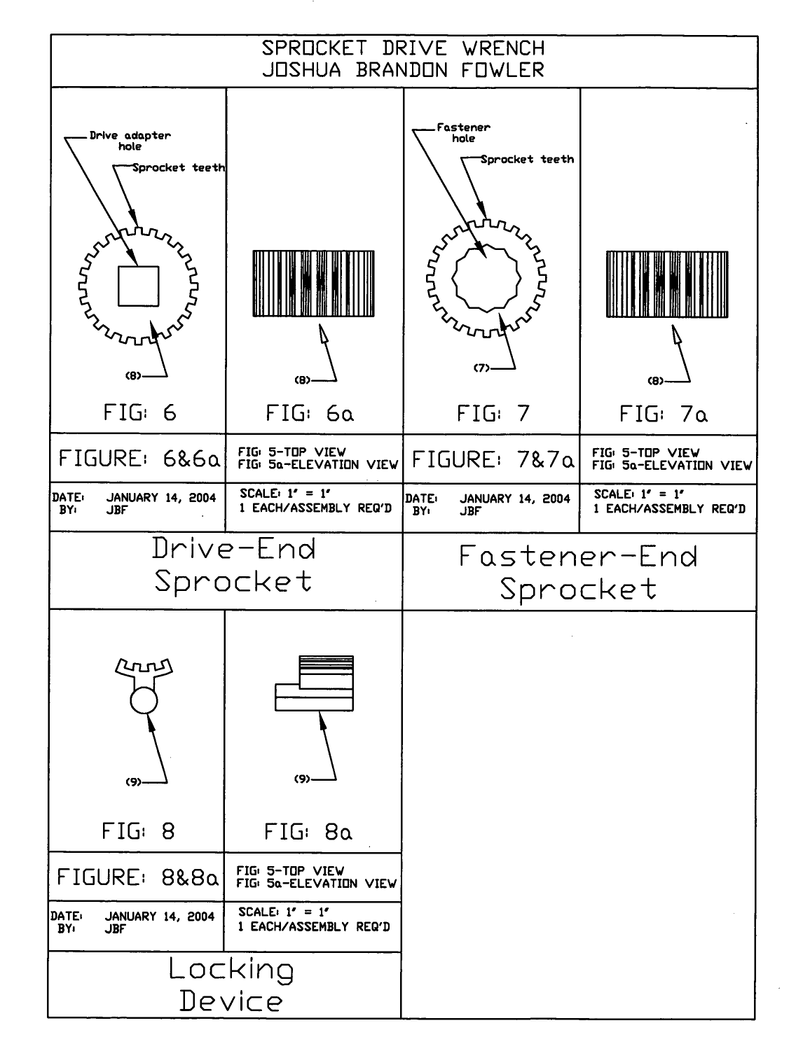

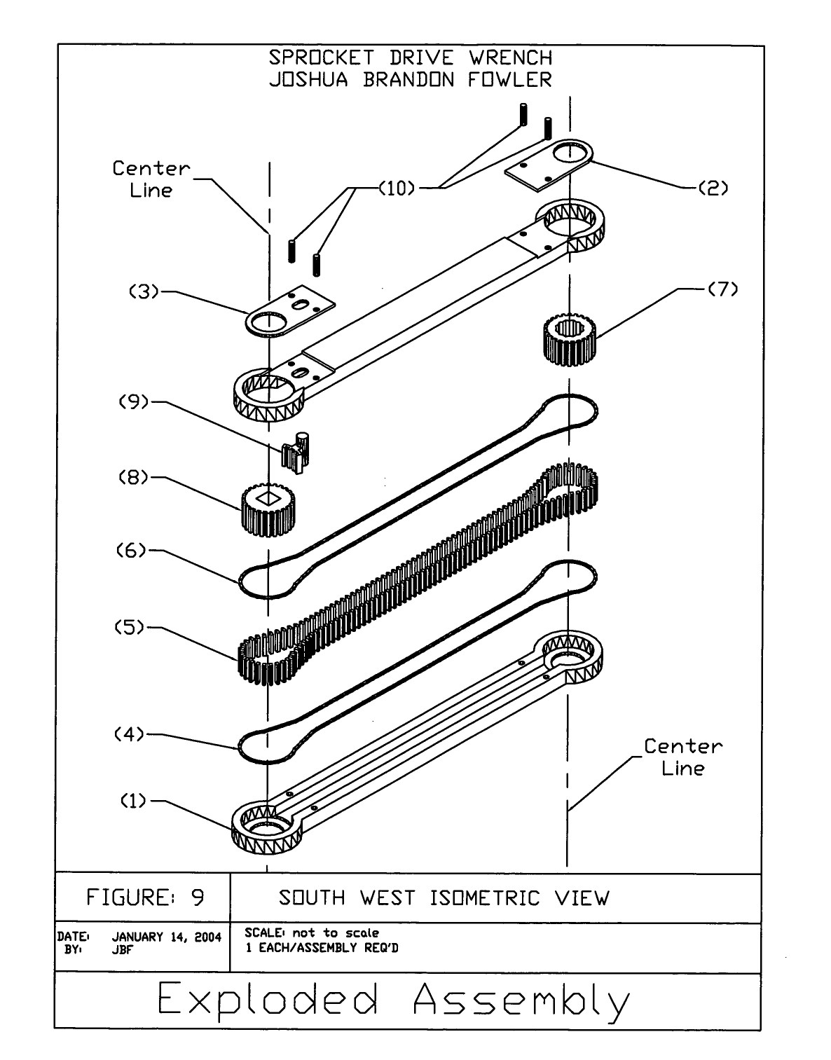

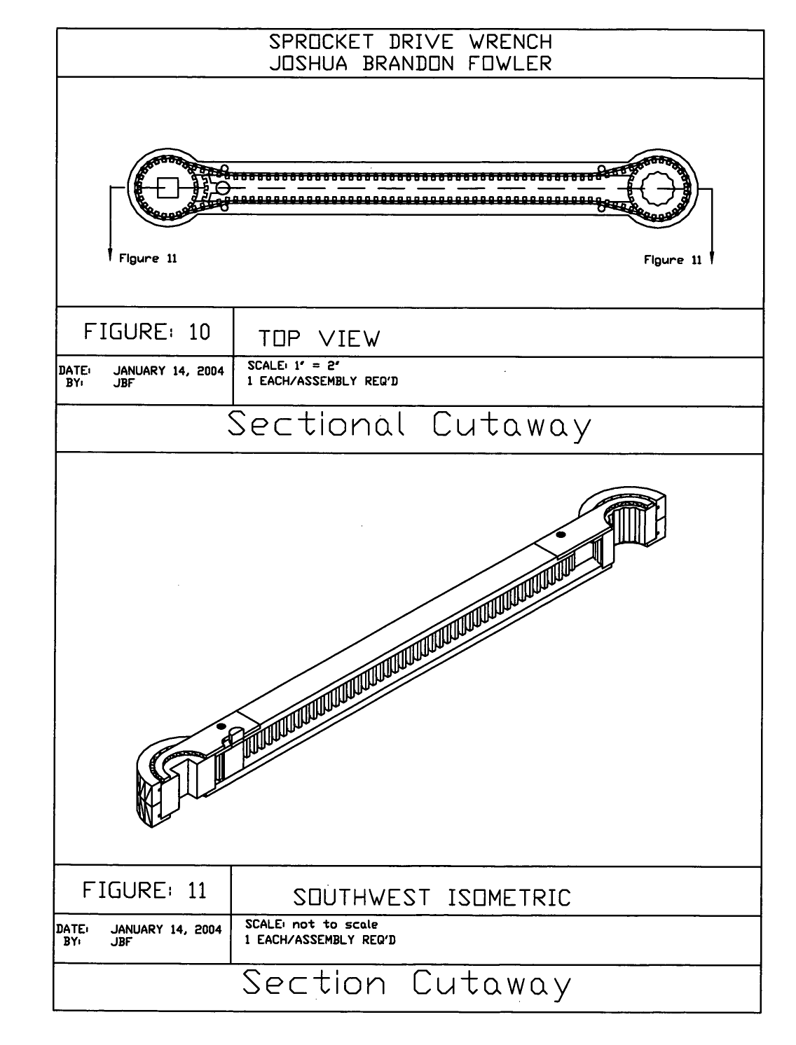

### LIST OF PARTS

(1) Main Housing-Bottom
(2) Fastener-End Access cover
(3) Drive-End Access cover
(4) Drive belt bottom retainer links
(5) Drive belt linkage
(6) Drive belt top retainer links
(7) Fastener-End Sprocket
(8) Drive-End Sprocket
(9) Locking Device
(10) Access Cover Fasteners
(11) Main Housing-Top

### DETAILED DESCRIPTION OF THE INVENTION

The wrench would be comprised of two assemblies; the main housing group, and the drive group.

The housing group (1) will be approximately 6 to 12 inches in length, ¾ inches in height, and 1 to 2 inches in width, made of steel or hardened material of the like. Cavities will be provided for the placement of Drive-End Sprocket (8) and Fastener-End Sprocket (7) as well as the insertion of the Drive Belt linkage (4,5, & 6). Access covers (2&3) will be secured during operation by 4 fasteners (10). The selectable locking device (9) will be installed prior to access cover (3) to be slide-lock or spring loaded. The Drive Belt path within the middle of the Main Housing is to be closer to the center than that around the outer surface of the End Sprockets. This allows more effective surface area contact between the sprocket and the drive belt.

The Fastener-End will be placed around the work piece. A ratchet or impact gun will be inserted into the drive-end sprocket. The force of the outside tool will drive the belt linkage and turn the work piece.

When an alternate sized fastener is to be tightened or loosened, the access cover can be quickly removed, the fastener-sprocket removed and an alternate size or type of fastener sprocket can be installed, the access cover reinstalled and work resume. In the event a sprocket or the belt linkage needs replaced due to damage, the same steps to change a fastener-sprocket should be followed.

The drive group consists of three components; the drive belt, the drive-end sprocket, and the fastener-end sprocket. The drive belt is a band of links connected at the top and bottom by linkage retaining clips (4)&(5) similar to those found in bicycles, motorcycles, chainsaws, or other chain driven devices. The drive-end sprocket is cylinder shaped approximately 3/4 to 1 inch in diameter, ⅝ inch in height. The perimeter surface is serrated with rectangular or triangular shaped “teeth”. The center is cut out to receive the drive shaft of a socket wrench or impact wrench. The fastener-end sprocket is identical in size and shape to the drive-end sprocket except for the center cutout is the shape of the fastener to be applied to (½, ⅜, ¾ inch . . . etc).

The drive belt is wrapped around both sprockets with maximum tension (within safe operating limits). A locking device will be installed on drive-end to allow the wrench to be used in the same manner as a conventional wrench. This allows the SPROCKET DRIVE WRENCH to be multifunctional as well as versatile.

1) The idea, components, and the application are of my initiation.

2) Using a sprocket chain or drive belt as the primary means of operating a wrench is a conceptual idea created by myself using only my personal experience and knowledge.

3) The design was created solely by me with no outside influence or help.

4) A main housing comprised of
a. Two halves
i. Top half comprised of
1. A Drive-End Sprocket through cavity
2. A Locking Device cutout
3. Access Cover seats for Access Covers
4. Access Cover Screw holes
5. A Fastener-End Sprocket through cavity
6. Two ends
a. A Drive-End
b. A Fastener-End
7. Handle comprised of
a. Drive Belt pathway
ii. Bottom half comprised of
1. A Drive-End Sprocket through cavity
2. A Locking Device seat
3. Access Cover Screw holes
4. A Fastener-End Sprocket through cavity
5. Two ends
a. A Drive-End
b. A Fastener-End
6. Handle comprised of
a. Drive Belt pathway

5) A Drive belt comprised of
a. Belt links that fit to sprocket teeth
b. Belt linkage retainers

6) Drive-End sprocket comprised of
b. A drive shaft bore
c. Rectangular teeth around the perimeter from top to bottom of sprocket

7) Fastener-End sprocket comprised of
d. A fastener shaped bore
e. Rectangular teeth around the perimeter from top to bottom of sprocket

8) Access covers comprised of
f. A circular cutout for sprocket access
g. Circular holes for access cover fastening
h. Fastening screws
